(19) United States
(12) Patent Application Publication
(10) Pub. No.: US 2004/0135333 A1
(43) Pub. Date: Jul. 15, 2004

(54) Wheelbarrow axle bushing

(76) Inventor: William Kurt Feick, New Canaan, CT (US)

Correspondence Address: ST. ONGE STEWARD JOHNSTON & REENS, LLC, 986 BEDFORD STREET, STAMFORD, CT, 06905-5619, US

(21) Appl. No.: 10/339,443

(22) Filed: Jan. 9, 2003

(51) Int. Cl. B62B 1/00

(52) U.S. Cl. 280/47.31

(57) ABSTRACT

A bushing for use with a wheel assembly for low speed vehicles or tools, the wheel assembly including a tire, a wheel disk securely holding the tire in a shape, and a hub connected inwardly to the wheel disk and defining a longitudinal opening for receiving an axle therein, the bushing including: a cylindrical body, including a first and a second end faces, and a cylindrical outer surface longitudinally extending between the first and the second end faces and configured to fit within the longitudinal opening of the hub, the cylindrical body defining a longitudinal bore extending between the first end face and the second face and configured to receive the axle therein, wherein the cylindrical body has a seating length between ⅝ inch and 11/8 inch, and the bushing is formed of oil-impregnated sintered metal. The bushing preferably includes a flange portion and a longitudinal groove at the out periphery of the cylindrical body.

### FIELD OF THE INVENTION

The present invention relates generally to a wheel assembly, and more particularly to a wheel assembly and associated bushings for low speed vehicles or tools such as wheelbarrows, carts, hand trucks, garden tools and the like.

### BACKGROUND OF THE INVENTION

Low speed, relatively light or medium load vehicles, for example wheelbarrows, carts, hand trucks, and garden tools, etc., utilize wheel assemblies Which include a wheel with a tire mounted thereto. The wheel usually includes a hub which is typically connected to the wheel disk at the inner space defined by the wheel disk. The hub includes an axial opening for receiving therein an axle and at least one bearing.

Bearings utilized in the wheel assemblies for such low speed vehicles facilitate smooth rotation of the wheel with respect to the axle. Generally, two conventional bearings commonly called sealed ball bearings or roller bearings are mounted within the opening of the hub, one to each end of the hub. Such bearings (for example, as shown in FIG. 5 ) include an inner ring having an axial opening for receiving the axle therein, a series of balls or rollers, and an outer ring to be press-fit and “seated” within the opening of the hub. Typical bearings used in wheel assemblies for the low speed vehicles have a “seating” length (“L” in FIG. 5) less than ⅝ inch along which the load of the vehicle applies.

Wheelbarrows and carts can be used for various purposes and applications such as for carrying construction and gardening materials, etc. They are often subject to severe operation conditions, such as sudden impacts on the body or the wheel. For example, such wheelbarrows and carts are commonly carried on trucks and then dropped to the ground directly onto the wheel. Such sudden impact on the wheel assembly often causes either ruining of bearings used therein by the impact, or the seating at the ends of the hub will flange the hub resulting in the bearings falling out from the wheel assembly. Flanging of the hub occurs partially because the seating area of the bearing into the hub is relatively small dictated by the seating length “L” as shown in FIG. 5.

### SUMMARY OF THE INVENTION

Accordingly, the present invention is directed to provide a construction of a wheel assembly with a bearing or bushing having a relatively long seating area inserting into the hub of the assembly. The bushing is preferably formed of oil-impregnated sintered metal and includes a cylindrical body with a longitudinal bore defined therein along the longitudinal axis for receiving an axle thereto. The longitudinal bore of the bushing preferably define a stepped bore having a larger opening in one side and a smaller opening in the other side of the bushing. The bushing preferably includes a flange portion in a outer periphery, and a groove formed axially along the outer cylindrical surface of the cylindrical body for receiving a welding seam line of the hub therein.

In accordance with one preferred embodiment of the invention, the wheel assembly for low speed vehicles or tools includes: a tire; a wheel disk defining an inner web portion, a main disk portion, and an outer rim for securely holding the tire in a fixed shape; a hub connected inwardly to the inner web portion of the wheel disk and defining a longitudinal opening for receiving an axle therein; and a bushing including a cylindrical body having a first and a second end faces and a cylindrical outer surface longitudinally extending between the first and the second end faces and configured to fit within the longitudinal opening of the hub, the cylindrical body defining a longitudinal bore extending between the first end face and the second face and configured to receive the axle therein, wherein the cylindrical body has a seating length between ⅝ inch and 11/8 inch. The bushing of the wheel assembly is preferably formed of oil-impregnated sintered metal. Alternatively, the bushing may be formed of other suitable material with a solid lubricant disposed at least adjacent to the longitudinal bore thereof. The longitudinal bore of the cylindrical body of the bushing preferably includes a stepped portion having one diameter in one end face and another diameter at the other end face thereof.

In accordance with another preferred embodiment of the invention, the bushing for use with a wheel assembly for low speed vehicles or tools is provided, in which the wheel assembly includes a tire, a wheel disk securely holding the tire in a shape, and a hub connected inwardly to the wheel disk and defining a longitudinal opening for receiving an axle therein. The bushing of the invention includes: a cylindrical body including a first and a second end faces and a cylindrical outer surface longitudinally extending between the first and the second end faces and configured to fit within the longitudinal opening of the hub, the cylindrical body defining a longitudinal bore extending between the first end face and the second face and configured to receive the axle therein, wherein the cylindrical body has a seating length between ⅝ inch and 11/8 inch. The bushing is preferably formed of oil-impregnated sintered metal. Alternatively, the bushing may be formed of other suitable material with a solid lubricant disposed at least adjacent to the longitudinal bore thereof. The longitudinal bore of the cylindrical body of the bushing preferably includes a stepped portion having one diameter in one end face and another diameter at the other end face thereof.

Other aspects, objects and features of the invention in addition to those mentioned above will be pointed out or will be understood from the following detailed description provided in conjunction with the accompanying drawings.

### BRIEF DESCRIPTION OF THE DRAWINGS

FIG. 1 is a perspective view of a wheelbarrow including a wheel assembly constructed in accordance with one embodiment of the invention.

FIG. 2 is a perspective view illustrating one exemplary construction of a wheel assembly.

FIG. 3 is a cross-sectional view of the wheel assembly constructed in accordance with the principles of the invention.

FIG. 4 is a side elevation view of a bushing constructed in accordance with the principles of the invention.

FIGS. 4A, 4B and 4C are side elevation views of alternative embodiments of the bushing of the invention.

FIG. 5 is a side cross-sectional view of a conventional roller bearing used Within a prior art wheel assembly.

### DETAILED DESCRIPTION OF THE DRAWINGS

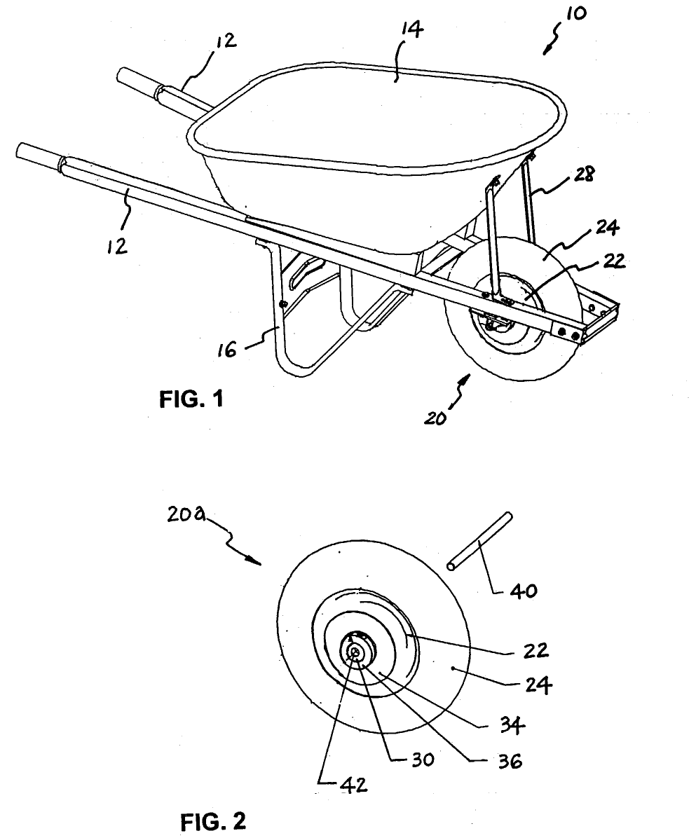

Referring now to the drawings, where like elements are identified by the same or similar reference number throughout the drawings, FIG. 1 illustrates a wheelbarrow, which is one exemplary vehicle or equipment for which the wheel assembly and its associated bushings of the present invention can be utilized therein. The invention is described herein mainly in connection with a wheelbarrow, however, the invention is also applicable to other low speed and/or relatively light or medium load vehicles, for example various types of carts, hand trucks, and garden tools, etc. Wheelbarrow 10 has a pair of extended frames 12, a bin or tub 14 and a pair of stands 16 respectively mounted to the frames 12. Wheelbarrow 10 further includes a wheel assembly 20 of the invention with a wheel disk 22 and a tire 24 rotatably connected with respect to the frames 12. Wheelbarrow 10 may further include other components such as brake components (not shown) and front supports 28, etc.

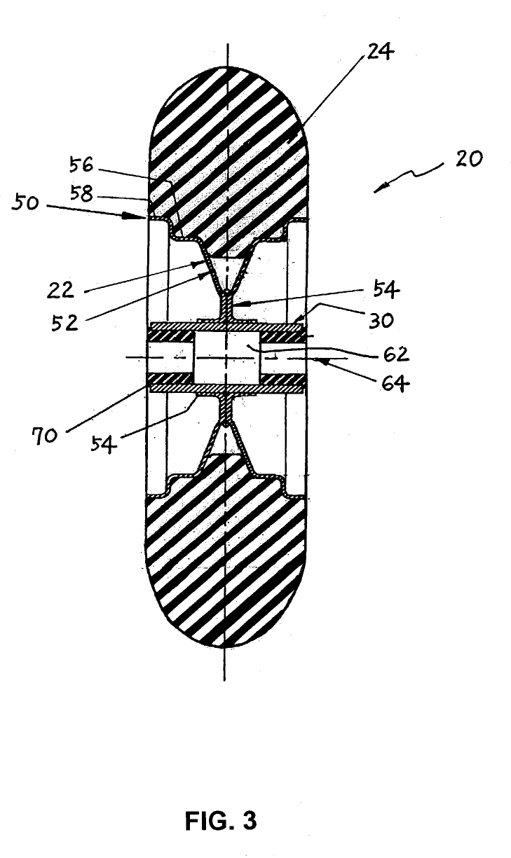

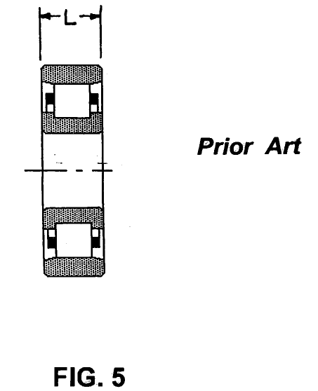

Referring to FIG. 2, an exemplary wheel assembly is described in detail. Wheel assembly 20a includes, in addition to a wheel disk 22 and a tire 24, a hub 30 and a disk collar assembly 34 with a mounting collar 36 tightly clamping the hub 30. An axle 40 is rotatably fit within a longitudinal opening 42 of the hub 30. Typical wheel assembly includes ball bearings or roller bearings (such as those shown in FIG. 5) inserted within the longitudinal opening 42 of the hub 30 for facilitating the rotation of the wheel with respect to the axle 40. Wheel assembly 20a may additionally include other functional components there-around.

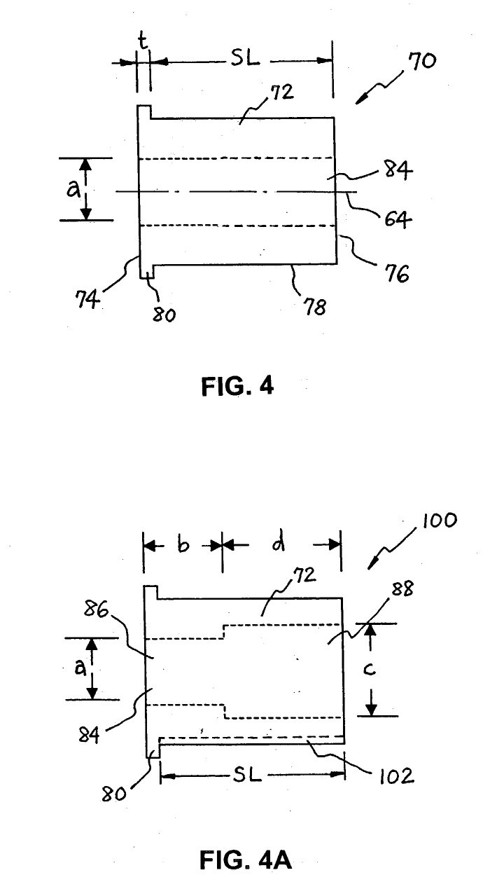

Referring now to FIG. 3, a wheel assembly 20 constructed in accordance with one preferred embodiment of the present invention is described herein. As mentioned above, wheel assembly 20 includes a wheel disk 22 and a tire 24 mounted on the wheel disk 22. Wheel disk 22 is made of suitable metal, and preferably composed of two pieces of disks welded, bonded or otherwise connected together, each piece including an outer rim portion 50, a disk portion 52 and an inner web portion 54. The rim portion 50 may further include axially extending shoulder portions 56 and 58 for providing a better load capacity to the disk. Tire 24 is made preferably of synthetic material such as polyurethane, or other plastic materials or synthetic rubber may be suitable. Tire 24 may be of the type substantially elastic or solid, or it may be a pneumatic tire well known in the art. Inner surface of the inner web portion 54 defines an axial opening, and a hub 30 is connected thereto, preferably by welding. Hub 30 is made of suitable metal and includes a cylindrical opening 62 along a longitudinal axis 64.

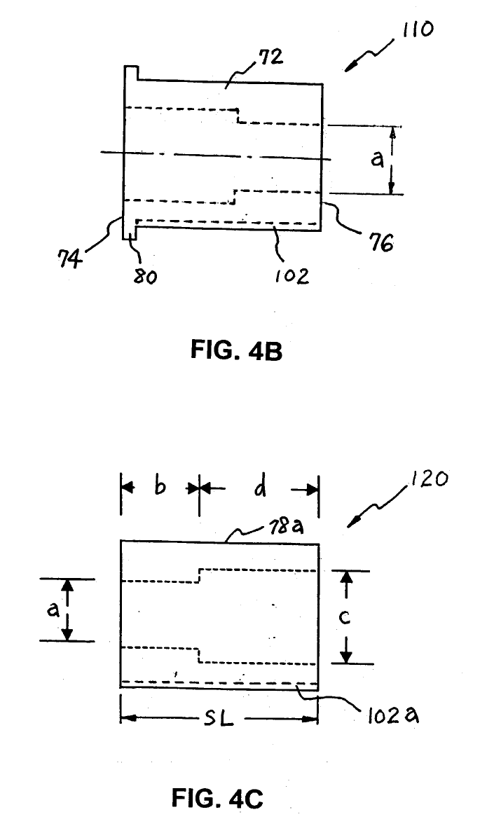

Referring now primarily to FIGS. 3-4, additionally to FIGS. 4A-4B a pair of bushings 70 are inserted, preferably by press fit, within the longitudinal opening 62 of the hub 30. Bushing 70 includes a cylindrical body 72 having a first end face 74, a second end face 76, and a cylindrical outer surface 78. The cylindrical outer surface 78 may include a flange portion 80 having a relatively small thickness “t” extending radially outward from the cylindrical outer surface 78 at an area near the first end face 74 (or the second end face 76). Alternatively, as shown in FIG. 4C, the cylindrical outer surface (“78a”) may be in the same diameter throughout the length. The cylindrical body 72 further defines a longitudinal cylindrical bore 84 along the longitudinal axis 64 for receiving an axle 40 (FIG. 2) which is rotatably mounted thereto. The longitudinal bore 84 may be a straight bore as shown in FIGS. 3-4, or may be a stepped bore as shown in FIG. 4A including a smaller opening 86 (with a diameter “a” and depth “b”) in the first end face 74 and a larger opening 88 (with a diameter “c” and depth “d”) in the second end face 76. The stepped bore may have the following exemplary dimensions: i.e., “a” is ⅝ inch, “b” is ⅜ inch, “c” is 11/16 inch, and “d” is ⅝ inch. This stepped bore configuration may have some advantages in controlling the friction force between the bushing and the axle 40 inserted to the bore of the bushing by adjusting the depth “b”, preferably together with the diameter “a”. It may also provide a room for receiving dust, metal sludge, or other remnant material or particles to be build up within the larger diameter area, thus, resisting from fouling of the wheels often resulting from long time use of the vehicles, particularly for carrying concrete, soil, and other construction or dusty materials.

Bushing 70 is preferably formed of sintered metal with lubricant oil impregnated within the inner porosity of the sintered material. Such impregnated-oil gradually discharges for a long time (for example, several years) and provides self-lubrication, therefore, low friction coefficients are maintained with respect to the mounting shaft or axle 40. After a while,, upon exhaustion of the lubricant oil from the inner porosity, bushing 70 may be processed to be re-impregnated with such lubricant oil, thereby extending its life. Forming of sintered metal (e.g., powder metal forming) and oil impregnation technologies are well known in the metal processing art. Steel powder or other metal powder may be used to form the sintered metal, preferably under high pressure.

Alternatively, bushing 70 may be formed of other suitable material with solid lubricants (for example, graphite) disposed there-around, at least adjacent to the inner surface of the bushing which contacts the axle 40. Such solid lubricants also function like the lubricant oil as above-described. In addition, a lubrication liquid (for example, grease or other liquid lubricants) may further be disposed adjacent to the contacting surface to further facilitate lubrication.

FIGS. 4A-4C illustrate alternate embodiments of the bushing of the present invention. Bushings 100 (FIG. 4A), 110 (FIG. 4B) and 120 (FIG. 4C) are similar to the bushing 70, except for several differences as discussed above or will be further described herein. In addition to defining a stepped bore as described, bushing 100 includes a longitudinal groove 102 disposed along the outer surface 78 of the cylindrical body 72. The groove is for receiving a weld seam line often existing along the inner surface of the hub 30 depending upon the production process of the hub, and has a semi-circular, triangular or substantially rectangular cross-sectional configuration corresponding to the shape of such Weld seam line of the hub. Bushing 110 is substantially similar to the bushing 100, however, its stepped bore portion is disposed in a reverse direction thereto. Bushing 120 is also similar to bushing 100 and includes similar longitudinal groove 102a along the outer surface 78 of the cylindrical body 72. However, unlike the bushings 70, 100 and 110, bushing 120 does not include a flange portion disposed at the cylindrical outer surface 78. Bushings 100, 110, 120 are also preferably formed of sintered metal with oil impregnated within the porosity of the sintered material. Alternatively, as described herein above, such bushings may be formed of other suitable material with solid lubricants (for example, graphite) disposed at least adjacent to the inner surface of the bushing which contacts the axle 40. In addition, a lubrication media (for example, grease or other liquid lubricants) may further be applied adjacent to the contacting surfaces thereof.

Referring FIGS. 4-4B, bushings 70, 100 and 110 define a “seating” length “SL” which is to be seated within the opening 62 of the hub. “Seating” length “SL” of the bushings of the invention is preferably between ⅝ inch and 11/8 inch, and more preferably about 1 (one) inch. This seating length is longer than the seating length “L” of the conventional bearings (such as shown in FIG. 5) which is at most ⅝ inch for ordinary wheels usable for low speed, relatively light duty vehicles such as wheelbarrows and carts. This enlarged seating area of the present invention provides substantial advantages over the prior art bearings. As mentioned, wheelbarrows and carts are often subject to excessive load or impact transmittable to the hub and to the bearings or the bushings. For example, wheelbarrows and carts are typically carried on a truck and often dropped to the ground onto the wheel. Such sudden impact on the wheel assembly often causes either ruining of bearings used therein by the impact, or the seating into the hub will flange the hub resulting in the bearings falling out from the wheel assembly. Flanging of the hub occurs partially because the seating area of the bearing into the hub is relatively small dictated by the seating length “L”. Therefore, utilizing a longer seating length “SL”, the wheel assembly of the present invention is particularly strong to prevent from the above-mentioned flanging of the hub. Moreover, with a wider seating area with enhanced mechanical strength, the wheel assembly of the invention can provide an extended outer clamping area on the hub onto which, for example, mounting collar 36 (FIG. 2) can be more tightly attached for certain functionalities.

Although the invention has been described and illustrated with respect to the exemplary embodiments thereof, it should be understood by those skilled in the art that various other changes, omissions, and additions may be made therein and thereto, without parting from the spirit and scope of the present invention.

What is claimed is:

1. A bushing for use with a wheel assembly for low speed vehicles or tools, the wheel assembly including a tire, a wheel disk securely holding the tire in a shape, and a hub connected inwardly to the wheel disk and defining a longitudinal opening for receiving an axle therein, said bushing comprising:
a cylindrical body including a first and a second end faces and a cylindrical outer surface longitudinally extending between the first and the second end faces and configured to fit within the longitudinal opening of the hub, the cylindrical body defining a longitudinal bore extending between the first end face and the second face and configured to receive the axle therein, wherein the cylindrical body has a seating length between ⅝ inch and 11/8 inch, and the bushing is formed of oil-impregnated sintered metal.

2. The bushing of claim 1, wherein the cylindrical body includes a flange portion having a thickness and extending radially outward from the cylindrical outer surface adjacent to one of the first and the second end faces thereof.

3. The bushing of claim 1, wherein the longitudinal bore of the cylindrical body is a stepped bore.

4. The bushing of claim 3, wherein the longitudinal bore of the cylindrical body includes a smaller diameter portion adjacent to one end face and a larger diameter portion adjacent to the other end face.

5. The bushing of claim 1, wherein the seating length defined by the cylindrical body is about one inch.

6. The bushing of claim 1, wherein the cylindrical body includes a longitudinal groove disposed along the cylindrical outer surface thereof.

7. The bushing of claim 6, wherein the longitudinal groove of the cylindrical body has a generally semi-circular cross-sectional configuration.

8. The bushing of claim 6, wherein the longitudinal groove of the cylindrical body has a generally triangular cross-sectional configuration.

9. The bushing of claim 6, wherein the longitudinal groove of the cylindrical body has a generally rectangular cross-sectional configuration.

10. The bushing of claim 1, wherein the cylindrical body is formed of sintered iron.

11. The bushing of claim 1, wherein the cylindrical body is formed from powder metal subjecting to a high temperature and high pressure condition.

12. A bushing for use with a wheel assembly for low speed vehicles or tools, the wheel assembly including a tire, a wheel disk securely holding the tire in a shape, and a hub connected inwardly to the wheel disk and defining a longitudinal opening for receiving an axle therein, said bushing comprising:
a cylindrical body including a first and a second end faces and a cylindrical outer surface longitudinally extending between the first and the second end faces and configured to fit within the longitudinal opening of the hub, the cylindrical body defining a longitudinal bore extending between the first end face and the second face and configured to receive the axle therein, wherein the cylindrical body has a seating length between ⅝ inch and 11/8 inch, and the bushing includes solid lubricant disposed at least adjacent to the longitudinal bore thereof.

13. The bushing of claim 12, wherein the solid lubricant includes graphite.

14. The bushing of claim 13, wherein the cylindrical body includes a longitudinal groove disposed along the cylindrical outer surface thereof.

15. The bushing of claim 13, wherein the longitudinal bore of the cylindrical body is a stepped bore.

16. A wheel assembly for low speed vehicles or tools, comprising:
a tire;
a wheel disk defining an inner web portion, a main disk portion, and an outer rim for securely holding the tire in a fixed shape;
a hub connected inwardly to the inner web portion of the wheel disk and defining a longitudinal opening for receiving an axle therein; and
a bushing including a cylindrical body having a first and a second end faces and a cylindrical outer surface longitudinally extending between the first and the second end faces and configured to fit within the longitudinal opening of the hub, the cylindrical body defining a longitudinal bore extending between the first end face and the second face and configured to receive the axle therein, wherein the cylindrical body has a seating length between ⅝ inch and 11/8 inch, and the bushing is formed of oil-impregnated sintered metal.

17. The wheel assembly of claim 16, wherein the cylindrical body of the bushing includes a flange portion having a thickness and extending radially outward from the cylindrical outer surface.

18. The wheel assembly of claim 16, wherein the longitudinal bore of the bushing is a stepped bore.

19. The wheel assembly of claim 18, wherein the longitudinal bore of the bushing includes a smaller diameter portion adjacent to one end face and a larger diameter portion adjacent to the other end face thereof.

20. The wheel assembly of claim 16, wherein the cylindrical body of the bushing includes a longitudinal groove disposed along the cylindrical outer surface thereof.

21. The wheel assembly of claim 16, wherein the cylindrical body of the bushing is formed from powder metal and being sintered under a high temperature and high pressure condition.

22. A wheel assembly for low speed vehicles or tools, comprising:
a tire;
a wheel disk defining an inner web portion, a main disk portion, and an outer rim for securely holding the tire in a fixed shape;
a hub connected inwardly to the inner web portion of the wheel disk and defining a longitudinal opening for receiving an axle therein; and
a bushing including a cylindrical body having a first and a second end faces and a cylindrical outer surface longitudinally extending between the first and the second end faces and configured to fit within the longitudinal opening of the hub, the cylindrical body defining a longitudinal bore extending between the first end face and the second face and configured to receive the axle therein, wherein the cylindrical body has a seating length between ⅝ inch and 11/8 inch, and the bushing includes solid lubricant disposed at least adjacent to the longitudinal bore thereof.

23. The wheel assembly of claim 22, wherein the solid lubricant includes graphite.

24. The wheel assembly of claim 23, wherein the cylindrical body includes a longitudinal groove disposed along the cylindrical outer surface thereof.

25. The wheel assembly of claim 23, wherein the longitudinal bore of the cylindrical body is a stepped bore.

26. A wheelbarrow comprising:
an extended frame;
a wheel assembly rotatably mounted to the extended frame, the wheel assembly including a tire, a wheel disk defining an inner web portion, a main disk portion, and an outer rim for securely holding the tire in a fixed shape, a hub connected inwardly to the inner web portion of the wheel disk and defining a longitudinal opening for receiving an axle therein, and a bushing including a cylindrical body having a first and a second end faces and a cylindrical outer surface longitudinally extending between the first and the second end faces and configured to fit within the longitudinal opening of the hub, the cylindrical body defining a longitudinal bore extending between the first end face and the second face and configured to receive the axle therein, wherein the cylindrical body has a seating length between ⅝ inch and 11/8 inch, and the bushing is formed of oil-impregnated sintered metal; and
a tub mounted to the extended frame for carrying material therein.

27. The wheelbarrow of claim 26, wherein the cylindrical body of the bushing includes a longitudinal groove disposed along the cylindrical outer surface thereof.

28. The wheelbarrow of claim 26, wherein the cylindrical body of the bushing includes a flange portion extending radially outward from the cylindrical outer surface.

29. The wheelbarrow of claim 26, wherein the longitudinal bore of the bushing is a stepped bore.

30. A wheelbarrow comprising:
an extended frame;
a wheel assembly rotatably mounted to the extended frame, the wheel assembly including a tire, a wheel disk defining an inner web portion, a main disk portion, and an outer rim for securely holding the tire in a fixed shape, a hub connected inwardly to the inner web portion of the wheel disk and defining a longitudinal opening for receiving an axle therein, and a bushing including a cylindrical body having a first and a second end faces and a cylindrical outer surface longitudinally extending between the first and the second end faces and configured to fit within the longitudinal opening of the hub, the cylindrical body defining a longitudinal bore extending between the first end face and the second face and configured to receive the axle therein, wherein the cylindrical body has a seating length between ⅝ inch and 11/8 inch, and the bushing includes solid lubricant disposed at least adjacent to the longitudinal bore thereof; and
a tub mounted to the extended frame for carrying material therein.
